(19) United States
(12) Patent Application Publication
(10) Pub. No.: US 2007/0105078 A1
(43) Pub. Date: May 10, 2007

(54) Rap teaching system and method

(76) Inventor: Charles G. Nanos, Portland, OR (US)

Correspondence Address: ROBERT D. VARITZ, P.C., 4915 SE 33RD PLACE, PORTLAND, OR, 97202, US

(21) Appl. No.: 11/588,770

(22) Filed: Oct. 27, 2006

Related U.S. Application Data
(60) Provisional application No. 60/733,513, filed on Nov. 4, 2005.

(51) Int. Cl. G09B 5/00

(52) U.S. Cl. 434/201; 434/307 R

(57) ABSTRACT

An enriched, memory-focused, sound-pattern synchronizing learning system and associated methodology. Systemically, the invention includes (a) an activatible sound-pattern source operable to create a student-hearable, rhythmic sound-pattern passage, (b) a family of plural learning-content phrases, including answer content, deliverable audibly to a student in rhythmic synchronization with such a passage, and (c) operatively associated with such a source and phrase family, an instruction set presentable to a student for encouraging sound-pattern-synchronized student response to the answer-content portions of such learning-content phrases.

### CROSS REFERENCE TO RELATED APPLICATION

This application claims priority to U.S. Provisional Patent Application Ser. No. 60/733,513, filed Nov. 4, 2005, for “Rap Teaching System and Method”. The entire disclosure content of that prior-filed provisional case is hereby incorporated herein by reference.

### BACKGROUND AND SUMMARY OF THE INVENTION

This invention relates to a system and a methodology for teaching which utilizes media rhythmic patterns, both audio, and if so desired, audio and video, administered to a student either directly and personally by a teacher/user, or by a suitable computer system, or by both. The relevant system of the invention is also referred to herein as an enriched, memory-focused, sound-pattern-synchronized learning system.

A preferred embodiment and manner of practicing the invention are described herein in conjunction with teaching basic multiplication tables to a category of students known as “kids at risk”—a term which is intended to refer to any adult, and/or young adult, population whose members face, or have faced, and may continue to face, significant societal and educational challenges.

The system and methodology of this invention have been developed specifically and experimentally in the setting of a juvenile detention center, wherein young pre-adult men and women have been placed temporarily for a variety of different reasons, and with respect to whom, the facility involved expressed an interest in developing a constructive learning environment for teaching certain basic schooling-related understandings, such as understandings of various aspects of mathematics.

With respect to a preferred manner of practicing and thinking about the invention, I have referred to a current version of this invention practice as “Multiplication Rap”, because of the fact that initial development of the invention has focused on teaching the basic multiplication tables utilizing a manner of synchrony-focused “delivery” to students which relates uniquely to “their world”—a world involving the “street environment” of “rap music” and “rap poetry” (i.e., speech). The invention is disclosed herein in this context.

Other subjects than mathematical multiplication may, of course, be taught and handled by practice of the invention, and those generally skilled in the art, on reading the invention disclosure contained herein, will understand how rhythmic patterns (which may be purely percussive) and musical, or musical-component, patterns, as described hereinbelow, can be employed to instill and cement certain kinds of fundamental learning in students who have experienced significant difficulties in conventional schooling settings.

Accordingly, and as was generally suggested above, all references to multiplication and mathematics herein should be understood to encompass other subjects suitable for learning in accordance with practice of the present invention.

Fundamentally, the teaching practice of this invention takes advantage of a natural interest which many young students, in the category mentioned above, have in the sound and feeling of so-called rap music and speech, and of course in any associated video imagery which is linked, typically rhythmically and synchronously, with such music. The teaching methodology involves delivering both instructions, teaching content, and questions (learning-content phrases including answer content) to a student, either completely orally, or orally and visually, in a manner involving, at least regarding the questions, the synchronous use of a rhythmic pattern which is set, for example, to a beat-per-minute mode of information delivery somewhere in the range of, typically, about 90-to-110-beats-per-minute. A rhythmic pattern, with or without a visual accompaniment, and preferably along with a suitable, rhythmically linked pattern of music, is delivered to a student along with a synchronously linked spoken, chanted or sung voice. Such a voice delivers instructional material on the one hand, and on the other, opens the opportunity for the student to learn, in the case of multiplication learning, by filling in (responding), (a) verbally, (b) by writing, or (c) by keypad entry into a suitable electronic data system, multiplication-table “product” information which the learner must provide as a delivered-question answer without being given any verbal or visual answer clue. Such an answer is referred to herein as a response, or a verbalization relative to the answer-content portion of a learning-content phrase (i.e., a question).

In one manner of practicing the invention, certain pre-instruction may be given to a student, whereby he or she is initially provided with multiplication table information (phrases) possessing correct “product” answers (answer content) in place, with such a student then being encouraged effectively, but with subtlety, to “turn on his or her learning memory” in ways that are promoted and enhanced by the synchrony-inviting, concurrent use of rap rhythmic and musical patterns, including rhythmically-synchronized speech.

From a reading of what follows below, those skilled in the art will recognize that the fundamental principle of this invention, that of linking, synchronously, rhythm, music and “self-verbalization”, can be implemented in a number of different, interesting and effective ways, all of which are considered to come within the scope of the present invention.

The various features and advantages of the invention will now become more fully apparent as the description which follows is read in conjunction with the accompanying drawings.

### DESCRIPTION OF THE DRAWINGS

FIG. 1 is a simplified block/schematic diagram illustrating one embodiment of, and also one manner of practicing, the present invention.

FIG. 2 is a schematic diagram which illustrates a “synchronous-screen-sequence” aspect of the present invention, wherein multiplication learning-content “phrases” are presented in the forms of whimsically dancing images appearing on a display screen under the control of an appropriately programmed digital computer during a learning session implementing the invention. The display screen pictured in FIG. 2 is the same as the display screen pictured as part of the block/schematic diagram of FIG. 1.

FIG. 3 is a facial illustration of a final CD and/or DVD product which may, if a user selects, or chooses, be provided to a student at the conclusion of a predetermined training session, or at the end of a series of training sessions, with this CD/DVD containing a recording of that student's synchronous, rap-verbalization learning responses to rhythm and music employed to teach multiplication.

FIGS. 4-7, inclusive, illustrate representative multiplication tables in the forms of well-known independent multiplication “learning-content phrases” for the numbers 1, 3, 7 and 9 presented to a student in the context of learning the basic multiplication tables. A representative “phrase” is “3×4=12”.

FIG. 8 represents a portion of a set of instructions presented in text form to a student learner, either in printed form, or perhaps on a computer-controlled display screen.

FIG. 9 represents another portion of an instruction set given to a student in the context of employing the present invention.

FIGS. 10 and 11 illustrate representative answer fill-in pages which may be given to a student to record the answers to questions (i.e., mathematical multiplication phrases) which may be presented in a random order, without answers (answer content), to a student, using sound and visual media behavior implemented by practice of the present invention.

FIG. 12 is a block/schematic diagram generally illustrating key steps implemented in the practice of the present invention.

FIG. 13 is a block/schematic diagram illustrating a slightly different system-form of the invention than that specifically illustrated in FIG. 1.

### DETAILED DESCRIPTION OF THE INVENTION

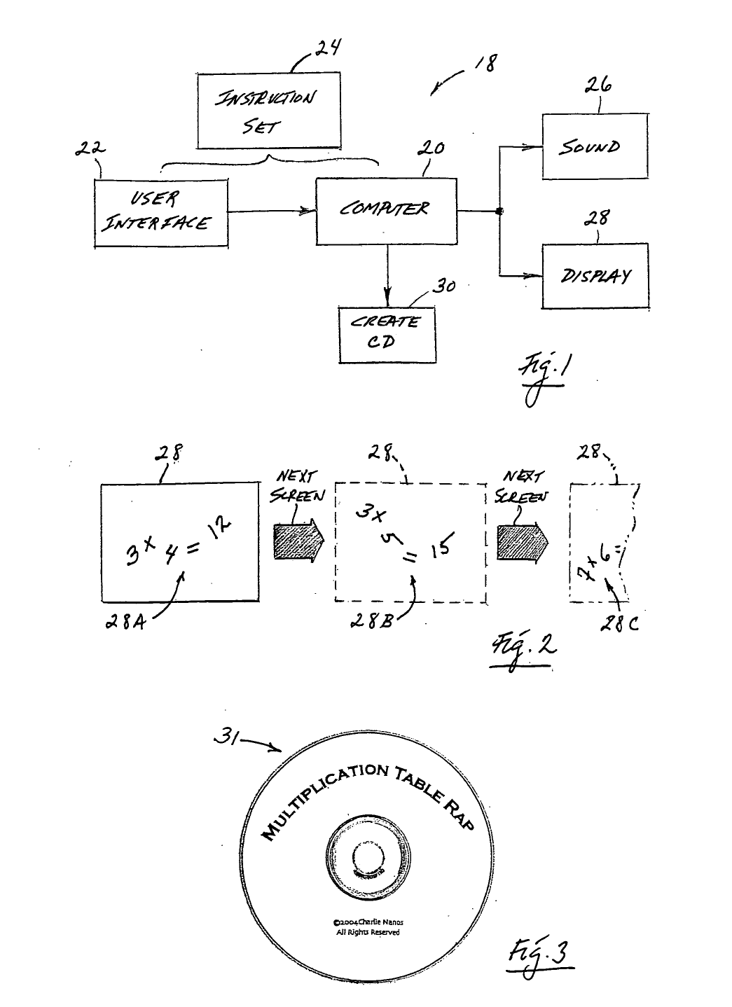

Turning now to the drawings, and referring first of all to FIG. 1, indicated generally at 18 is one preferred form of a rhythm-synchronous learning system constructed in accordance with the present invention. System 18 is represented in FIG. 1 by six blocks 20, 22, 24, 26, 28, 30. Block 20 represents a suitably programmed digital computer which functions herein as an activatible sound-pattern source operable to create what is referred to as a student-hearable, selectively recordable, predictable sound-pattern passage which may be presented via a suitable sound device represented by block 26. This sound device might typically be a set of earphones, or a loudspeaker. Computer 20 also functions herein both as an optionally useable sound-recording instrumentality, and as an optionally useable visual-image recording instrumentality.

Student interaction in system 18 is accommodated by appropriate interface structure which is represented by block 22. This interface structure may include a device for controlling the operation of computer 20, as in the form of a keyboard, a mouse, a joystick, a numeric keypad, etc., and block 22 may also include a student-useable audio input device, such as a microphone, which feeds an audio stream into computer 20 for optional recording therein in accordance with one manner of practicing the invention.

Block 24 represents an instruction set which is provided to a student in association with the operations of computer 20 and interface 22, and this instruction set may be provided either (a) in written paper form, (b) on a suitably computer-controlled display screen, such as that represented by block 28 in FIG. 1, (c) by a sound recording played out by computer 20 over the appropriate sound device represented by block 26, and/or (d) directly by an attending instructor/teacher (administrative user). As will become apparent from a description of a typical manner of employing system 20 in a teaching mode with respect to multiplication tables, after certain preliminary steps are taken to assess a student's initial understanding of basic multiplication tables, the student is asked to respond to a series of, for example, written questions (learning-content phrases) in the forms of incomplete mathematical equations which leave multiplication product answers in a blank condition ready for filling in (responding to) as best understood by a student.

After preliminary student assessment has taken place, a student is encouraged either under his or her own control, or under the control of an administrative user, to play out a created rhythmic and/or musical-content passage which makes multiplication equation statements in the form of rhythmic patterns matched to the rhythm of music. For example, such statements may be presented as complete equations that give the answers (i.e., which possess “filled-in” answer content), or may be presented in a manner which invites a student to enter answers to incompletely, and preferably randomly, stated but rhythmically presented phrases (i.e., learning-content phrases whose answer-content portions are blank). “Entry” of an answer ( a student responsive “verbalization”, or “self-verbalization”) may take place by writing, by using a numeric keypad, or by speech which may optionally be dutifully recorded by computer 20.

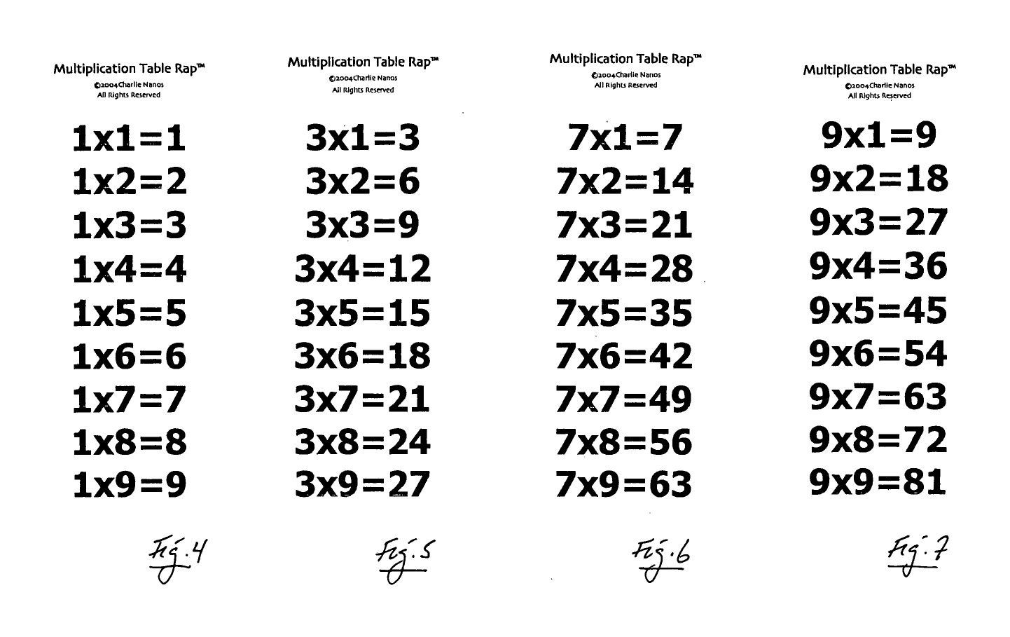

During all of this activity, it is additionally possible to present, in a one-after-another, rhythmically synchronized fashion, colorful, dancing, fanciful and whimsical multiplication-table graphic forms, if desired, each “displaying” an individual mathematical phrase or equation, with or without provided answers. This possibility is illustrated by three progressive “dancing” motion displays shown at 28A, 28B, 28C on screen 28 in FIG. 2 in the drawings.

At some point in time, and typically at an “advanced” stage of instruction and learning, a student may be encouraged simply to activate a musical/rhythmic pattern passage with respect to which the student, in his or her chosen rhythmic way, makes full rap-fashion statements in the forms of mathematical-table equations (phrases) to the beat of the activated rhythmic or musical pattern, with all of this being recorded, selectively, and optionally, if so desired, by the computer in a manner which can be later played out from a saved or recorded condition, and ultimately presented to the student in archival CD or DVD forms, as is generally represented by block 30 in FIG. 1. FIG. 3 illustrates such a CD/DVD at 31.

Practical implementation of this system, generally practiced as outlined above, has shown remarkable success in utilizing the youth world of rap music to develop clearly retainable learning of material, such as mathematical multiplication tables, where the learning process links, with a selected rhythmic pattern of percussion and/or music, multiplication-equation phrases seeking student answers that are written, keypad-entered, or spoken by a student in a synchronized rhythmic fashion. Learning reinforcement may be accomplished, among other ways, by recording, for replay and CD or DVD archiving, a student's “performance”.

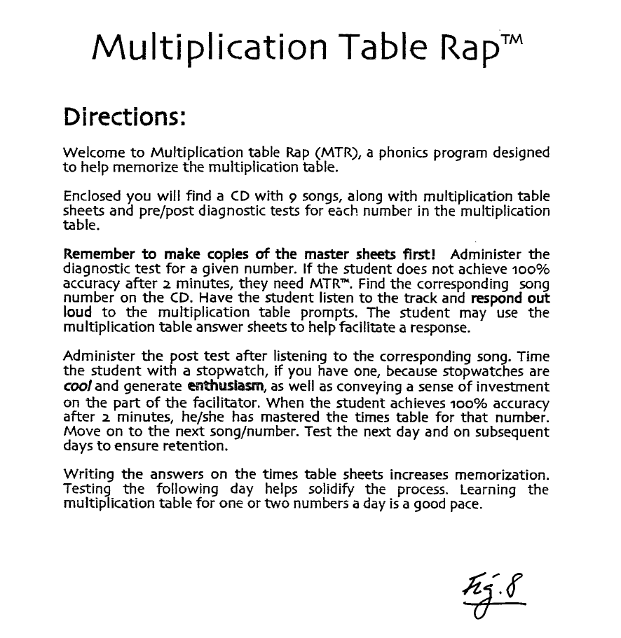

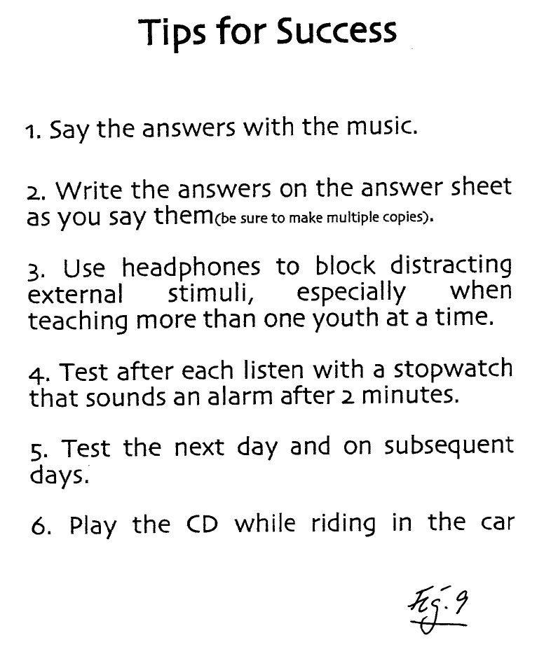

FIGS. 4-7, inclusive, illustrate four different representative multiplication tables which might be presented to a student orally, visually or in some combination of oral and visual presentation early in the learning process, and perhaps after initial student testing, to provide the student with at least one period of exposure to correct answers to multiplication table equations.

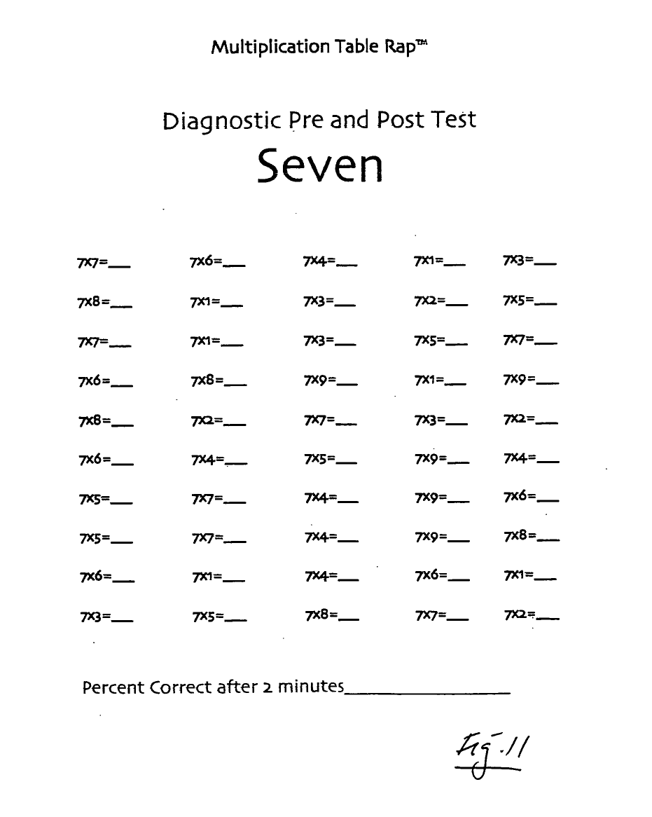

FIGS. 10 and 11 illustrate preliminary test sheets which may be employed to test a student's initial retention of mathematical equation correctness in a kind of random fashion, and under circumstances with each presented mathematical phrase repeated several times. Use of material such as is illustrated in these two figures might be repeated many times, during early learning, against a sound background of rhythm and music in which someone other than the student is speaking the mathematical phrases both with and without answers.

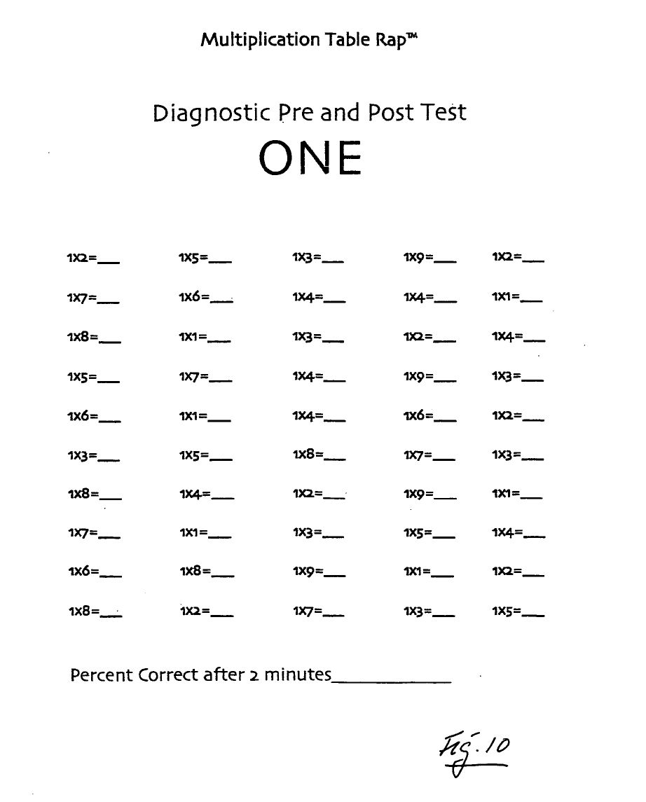

Appropriate instructions in a set are presented to a student either on paper, on a display screen, orally under to control of a computer, by an instructor, or in a combination of these ways, clearly outlining to a student the various learning and testing tasks which are involved in implementation of the invention. FIGS. 8 and 9 in the drawings illustrate representative instructions sets designed to be used in operative association with the employed source of rhythmic patterns and the related learning-content phrases. Those generally skilled in the art will understand how to create, from the description of the invention given herein, appropriate instruction sets for different particular fields of learning.

In addition to the situation of a student emerging from a comprehensive training session potentially, and optionally, with something like the audio CD, it is entirely possible that a video display, such as the dancing equation display pictured in FIG. 2, might also be recorded and presented along with a recorded song track in a DVD format.

It is also contemplated that a student may be given a relative amount of freedom to control the specific rhythmic and/or musical pattern which is employed by him or her to learn and to record rap responses in accordance with practice of the invention, and it is also entirely possible for a student to be provided with an appropriate user interface, relative to a computer, for example, to generate a self-invented rhythmic and/or musical pattern for use.

FIG. 13 in the drawings more specifically illustrates a form of the invention including seven illustrative blocks which picture a system arrangement that may include student opportunity for designing and creating self-generated rhythmic and music patterns for learning purposes. This arrangement of blocks includes labeled blocks 32, 34, 36, 38, 40, 42, 44 organized in what is believed to be quite a self-explanatory arrangement. In this arrangement, block 36 represents in suitable recording instrumentality which might be part of a digital computer, such as computer 20 shown in FIG. 1. Block 42 represents a recording of a student's performance, potentially both orally and visually, and this record might also be retained in a memory within a digital computer such as computer 20. Block 44 represents the same thing in FIG. 13 that block 30 represents in FIG. 1, and namely the output production optionally and selectively of a CD which contains either simply sound information, or which is produced in a DVD format to include visual information, such as the same kind of dancing screen equation information pictured generally in FIG. 2.

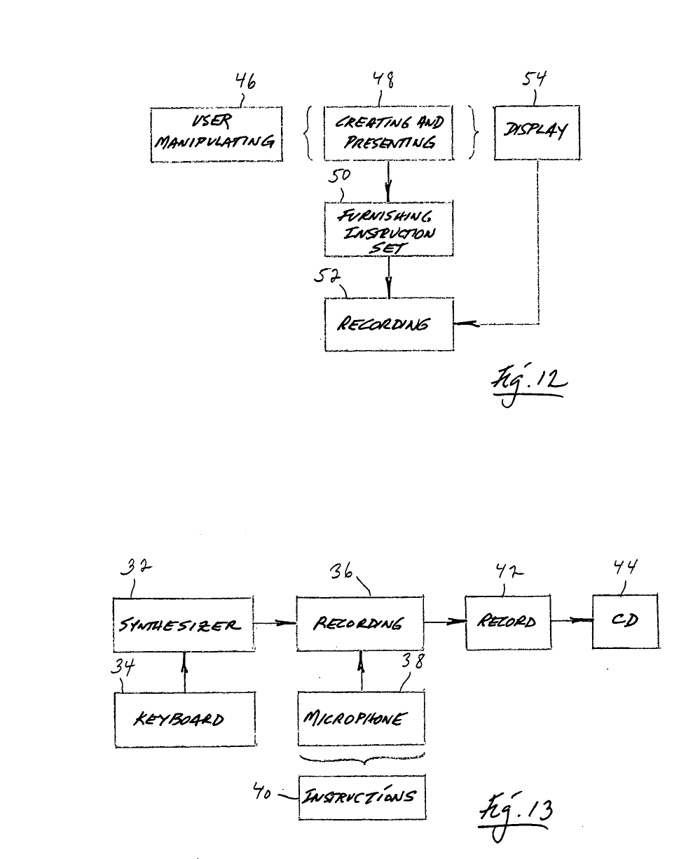

Looking finally at FIG. 12 in the drawings, here, in five blocks 46, 48, 50, 52, 54, the basic methodology of the invention is represented. In terms of what is pictured in FIG. 12, the invention methodology can be described as being an enriched, memory-focused, sound-pattern synchronized learning method including the steps of (a) creating and presenting (block 48) a student-hearable, rhythmic sound-pattern passage, (b) furnishing an instruction set (block 50) which outlines and encourages potentially recordable, presented-sound-pattern-synchronized, user answer responses relative to a family of created learning-content phrases having answer-content portions, and (c) optionally recording (block 50), in a preservable and user-replayable manner, an archival sound and/or video recording which links, in time-locked relation, student learning-content answers and a created, presented and associated sound-pattern passage.

It is understood that the creating and presenting steps of the invention involve a sound-pattern passage which is at least one of (a) a rhythmic pattern (typically percussive), and (b) a musical pattern. The method of the invention further includes enabling student manipulation (block 46) and changing, including designing, of such a created and presented sound-pattern passage.

The furnishing step of the invention involves providing a student with an appropriate instruction set containing an indication about how to work with mathematical multiplication phrases (equations).

Additionally, the invention contemplates placing, if desired, on a display screen (block 54) a visual display including time-synchronized imagery relating to the mentioned learning-content phrases, and archivally recording such a display along with an optional, recorded sound recording. The display presented may, as is suggested in FIG. 2, be a motion display, and in particular, one which is characterized by whimsical and fanciful mathematical equation dancing motion linked to an associated rhythmic pattern.

Accordingly, a unique, rap-like, rhythmic methodology, and an associated system, in several different forms, have been described and illustrated herein. These thus illustrated and described invention forms do not exhaustively present the invention. Rather, they showcase it in a manner which will surely suggest to those skilled in the art that there are many other variations and modifications of the invention which can be invoked, and which will come within the scope of the claims herein.

I claim:

1. An enriched, memory-focused, sound-pattern-synchronizing learning system comprising
an activatible sound-pattern source operable to create a student-hearable, rhythmic, sound-pattern passage,
a family of plural learning-content phrases, including answer content, deliverable audibly in rhythmic synchronization with such a passage, and
operatively associated with such a source and said family, an instruction set presentable to a student for encouraging sound-pattern-synchronized, student responses to the answer-content portions of such learning-content phrases.

2. The system of claim 1, wherein said source is specifically operable to create such a sound-pattern passage which includes a musical-component pattern.

3. The system of claim 1 which further comprises structure operatively connected to said source enabling selective student manipulation and changing, including designing, of the sound-pattern passage created by said source.

4. The system of claim 1, wherein the mentioned learning-content phrases take the form of mathematical multiplication phrases.

5. The system of claim 1, wherein at least one of said source and said instruction set is linked to, or directly implemented by, a digital computer.

6. The system of claim 1 which further includes a recording instrumentality operatively associated both with said source and with said instruction set, operable to produce a selectively preservable and replayable archival sound record linking, in time-locked relation, student learning-content responses to the answer-content portions of activated and created sound-pattern passages.

7. The system of claim 1, wherein a sound-pattern passage has a quality of predictability, while said instruction set is delivered to a student with a quality of randomness.

8. The system of claim 6 which further includes a digital computer and an operatively connected computer-driven display screen which are operatively associated (a) with said source, (b) with said recording instrumentality, and (c) with said instruction set, and said computer places on said screen a visual display including imagery relating to the mentioned learning-content phrases.

9. The system of claim 8, wherein said recording instrumentality is structured to record sound and visual imagery.

10. The system of claim 8, wherein the visual display placed on said display screen by said computer is a motion display.

10. The system for claim 9, wherein said motion display is characterized by whimsical and fanciful dancing motion.

11. An enriched, memory-focused, sound-pattern learning method comprising
creating and presenting to a student a hearable, rhythmic, sound-pattern passage,
generating a family of plural learning-content phrases, including answer content, which are deliverable audibly in rhythmic synchronization with such a created sound-pattern passage,
delivering such a family of phrases to a student, and
in relation to said delivering, furnishing to the student an instruction set which encourages sound-pattern-synchronized, student responses to the answer-content portions of such learning-content phrases.

12. The method of claim 11, wherein said creating involves generating as a part of a created sound-pattern passage, an associated musical-component pattern.

13. The method of claim 12 said creating includes enabling student manipulation and changing, including designing, of the mentioned sound-pattern passage.

14. The method of claim 12, wherein a generated family of learning-content phrases contains mathematical multiplication phrases.

15. The method of claim 12 which further comprises placing on a display screen a visual display including imagery related to the mentioned learning-content phrases.

16. The method of claim 15, wherein such a placed, visual display is a motion display.

17. The method of claim 16, wherein such a motion display is characterized by whimsical and fanciful dancing motion.
